(19) United States
(12) Patent Application Publication
(10) Pub. No.: US 2021/0192458 A1
(43) Pub. Date: Jun. 24, 2021

(54) ENHANCED OUT-OF-OFFICE SYSTEM AND METHODS FOR EMAIL CLIENTS

(71) Applicant: Citrix Systems, Inc., Ft. Lauderdale, FL (US)

(72) Inventors: Jeevan Nagaraj, Bangalore (IN); Monashree R, Bangalore (IN); Ramadas S. Mahale, Bangalore (IN)

(73) Assignee: Citrix Systems, Inc., Ft. Lauderdale, FL (US)

(21) Appl. No.: 16/724,566

(22) Filed: Dec. 23, 2019

(51) Int. Cl. G06Q 10/10; H04L 12/58

(52) U.S. Cl. CPC G06Q 10/107; H04L 51/043; H04L 51/12

(57) ABSTRACT

A computer system is provided. The computer system includes a memory and at least one processor coupled to the memory and configured to determine that a current date is within an out-of-office (OOO) time period; receive an email from a mail server; apply a set of email rules to the email to determine that a notification of the email may be blocked; block the notification of the email in response to the determination that the current date is within the OOO period and the determination that the notification of the email may be blocked; apply a set of event rules to a reminder of an event invitation to determine that the reminder may be blocked; and block the reminder in response to the determination that the current date is within the OOO period and the determination that the reminder may be blocked.

### BACKGROUND

Some email clients provide the capability for users to access their emails from mobile devices and other platforms while they are away from their office or otherwise on the move. These email clients also usually offer basic Out-of-Office (OOO) features which, for example, allow users to notify email senders of the user's inability to respond, through an automated reply.

### SUMMARY

In at least one example, a computer system is provided. The computer system includes a memory; and at least one processor coupled to the memory and configured to: determine that a current date is within an out-of-office (OOO) time period; receive an email from a mail server; apply a set of email rules to the email to determine that a notification of the email is allowed to be blocked; block the notification of the email in response to the determination that the current date is within the OOO time period and the determination that the notification of the email is allowed to be blocked; apply a set of event rules to an event invitation to determine that a reminder of the event invitation is allowed to be blocked; and block the reminder in response to the determination that the current date is within the OOO time period and the determination that the reminder is allowed to be blocked.

At least some examples of the computer system can include one or more of the following features. The event is a first event and the at least one processor can be configured to: receive an invitation to a second event from the mail server; determine that the second event is scheduled to occur during the OOO time period; apply the set of event rules to the second event to determine that the invitation is allowed to be declined; and decline the invitation in response to the determination that the second event is scheduled to occur during the OOO time period and the determination that the invitation is allowed to be declined. The event is a first event and the at least one processor can be configured to: determine that a previously accepted invitation to a second event is scheduled to occur during the OOO time period; apply the set of event rules to the second event to determine that the previously accepted invitation is allowed to be declined; and decline the previously accepted invitation in response to the determination that the second event is scheduled to occur during the OOO time period and the determination that the previously accepted invitation is allowed to be declined. The at least one processor can be configured to perform natural language processing on one or more additional emails received from the mail server to identify the OOO time period. The at least one processor can be configured to receive a leave approval message from a management portal and identify the OOO time period based on the leave approval message. The set of email rules can include data items to be matched to attributes associated with the email, a match indicating that the notification of the email should not be blocked, the data items including one or more of a list of email senders, an email classification tag, an email importance tag, an email flag, an email destination folder, an email subject, a list of email recipients, a specified phrase in the email, and an instance of an at-sign in conjunction with a specified name. The set of event rules can include data items to be matched to attributes associated with the event, a match indicating that a reminder of the event should not be blocked and that an invitation to the event should not be declined, the data items including one or more of an event inviter, a list of event invitees, an event importance tag, and event flag, an event subject, and a specified phrase in the invitation to the event.

In at least one example, a method for providing an enhanced out-of-office (OOO) mode to an email client is provided. The method includes determining, by a computer system, that a current date is within an OOO time period; receiving, by the computer system, an email from a mail server; applying, by the computer system, a set of email rules to the email to determine that a notification of the email is allowed to be blocked; blocking, by the computer system, the notification of the email in response to the determination that the current date is within the OOO time period and the determination that the notification of the email is allowed to be blocked; applying, by the computer system, a set of event rules to an event invitation to determine that a reminder of the event invitation is allowed to be blocked; and blocking, by the computer system, the reminder in response to the determination that the current date is within the OOO time period and the determination that the reminder is allowed to be blocked.

At least some examples of the method can include one or more of the following features. Wherein the event is a first event, the act of receiving an invitation to a second event from the mail server; determining that the second event is scheduled to occur during the OOO time period; applying the set of event rules to the second event to determine that the invitation is allowed to be declined; and declining the invitation in response to the determination that the second event is scheduled to occur during the OOO time period and the determination that the invitation is allowed to be declined. Wherein the event is a first event, the act of determining that a previously accepted invitation to a second event is scheduled to occur during the OOO time period; applying the set of event rules to the second event to determine that the previously accepted invitation is allowed to be declined; and declining the previously accepted invitation in response to the determination that the second event is scheduled to occur during the OOO time period and the determination that the previously accepted invitation is allowed to be declined. The act of performing natural language processing on one or more additional emails received from the mail server to identify the OOO time period. The act of receiving a leave approval message from a management portal and identifying the OOO time period based on the leave approval message. The set of email rules can include data items to be matched to attributes associated with the email, a match indicating that the notification of the email should not be blocked, the data items including one or more of a list of email senders, an email classification tag, an email importance tag, an email flag, an email destination folder, an email subject, a list of email recipients, a specified phrase in the email, and an instance of an at-sign in conjunction with a specified name. The set of event rules can include data items to be matched to attributes associated with the event, a match indicating that a reminder of the event should not be blocked and that an invitation to the event should not be declined, the data items including one or more of an event inviter, a list of event invitees, an event importance tag, and event flag, an event subject, and a specified phrase in the invitation to the event.

In at least one example, a non-transitory computer readable medium storing executable sequences of instructions to provide an enhanced out-of-office (OOO) mode to an email client is provided. The sequences of instructions include instructions to: determine that a current date is within an OOO time period; receive an email from a mail server; apply a set of email rules to the email to determine that a notification of the email is allowed to be blocked; block the notification of the email in response to the determination that the current date is within the OOO time period and the determination that the notification of the email is allowed to be blocked; apply a set of event rules to an event invitation to determine that a reminder of the event invitation is allowed to be blocked; and block the reminder in response to the determination that the current date is within the OOO time period and the determination that the reminder is allowed to be blocked.

At least some examples of the non-transitory computer readable medium can include one or more of the following features. Wherein the event is a first event, instructions to receive an invitation to a second event from the mail server; determine that the second event is scheduled to occur during the OOO time period; apply the set of event rules to the second event to determine that the invitation is allowed to be declined; and decline the invitation in response to the determination that the second event is scheduled to occur during the OOO time period and the determination that the invitation is allowed to be declined. Wherein the event is a first event, instructions to: determine that a previously accepted invitation to a second event is scheduled to occur during the OOO time period; apply the set of event rules to the second event to determine that the previously accepted invitation is allowed to be declined; and decline the previously accepted invitation in response to the determination that the second event is scheduled to occur during the OOO time period and the determination that the previously accepted invitation is allowed to be declined. Instructions to perform natural language processing on one or more additional emails received from the mail server to identify the OOO time period. Instructions to receive a leave approval message from a management portal and identify the OOO time period based on the leave approval message. The set of email rules can include data items to be matched to attributes associated with the email, a match indicating that the notification of the email should not be blocked, the data items including one or more of a list of email senders, an email classification tag, an email importance tag, an email flag, an email destination folder, an email subject, a list of email recipients, a specified phrase in the email, and an instance of an at-sign in conjunction with a specified name. The set of event rules can include data items to be matched to attributes associated with the event, a match indicating that a reminder of the event should not be blocked and that an invitation to the event should not be declined, the data items including one or more of an event inviter, a list of event invitees, an event importance tag, and event flag, an event subject, and a specified phrase in the invitation to the event.

Still other aspects, examples, and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a top-level block diagram of a client email application employing an Extended out-of-office (EOOO) system, in accordance with an example of the present disclosure.

FIG. 2 is a block diagram of the EOOO system, in accordance with an example of the present disclosure.

FIG. 3 illustrates EOOO mode trigger processing procedures, in accordance with an example of the present disclosure.

FIG. 4 illustrates EOOO mode processing procedures for emails and invitations, in accordance with an example of the present disclosure.

FIG. 5 is a flow diagram of a process for providing an EOOO mode to an email client, in accordance with an example of the present disclosure.

FIG. 6 illustrates a graphical user interface (GUI) for the EOOO system, in accordance with an example of the present disclosure.

FIG. 7 illustrates another GUI for the EOOO system, in accordance with an example of the present disclosure.

FIG. 8 is a block diagram of a computing platform configured to perform a process for providing an EOOO mode to an email client, in accordance with an example of the present disclosure.

### DETAILED DESCRIPTION

As noted previously, email clients generally provide the capability for users to access their emails from mobile devices and other platforms while they are away from their office. These email clients also usually provide rudimentary Out-of-Office (OOO) features which allow a user to notify email senders that the user is away and unable to respond. Generally, however, existing OOO functionality offers limited ability to handle a wide range of situations and does not allow the user to flexibly customize the OOO functionality to the user's particular needs. For example, when notifying users, all emails are generally treated the same during an OOO time period.

To address these problems, and as summarized above, various examples described herein are directed to systems and methods for providing an enhanced OOO (EOOO) functionality. In some examples, both email notifications and event invitation reminders may be blocked during the OOO time period. In some examples, new invitations to events that are scheduled to occur during the OOO time period may be declined and accompanied by an OOO message of the user's choosing. Additionally, previously accepted invitations to events, that the EOOO system subsequently determines are scheduled to occur during the OOO time period, may be rescinded or withdrawn along with the transmission of the OOO message. For example, a user may have accepted an invitation to an event prior to deciding to go on leave, and thus the organizer would otherwise be unaware of the fact that the user will be unable to attend the event.

In some examples, the EOOO system enables the user to specify rules that may be applied to the data or metadata associated with incoming emails and event invitations, to determine whether or not notifications of the email should be blocked and/or invitations declined. For example, the rules may be employed to determine that some emails and invitations are more important than others and thus should not be blocked or declined, as will be explained in greater detail below.

As another example, the EOOO system may be configured to automate the determination of the OOO time period, eliminating the requirement that the user manually provide this information. For example, the automated determination may be based on the application of natural language processing techniques to incoming or outgoing emails, as will be explained in greater detail below, to recognize that the user is planning to go on vacation, or take some type of leave, over a certain range of dates and times. Alternatively, the EOOO system may monitor and management portal to detect and recognize a request to management for leave, or an approval of same from management.

In some examples, the EOOO system allows the user to enable or disable the EOOO functionality with a single control, such as the click of a button on a user interface.

As will be understood in view of this disclosure, the systems and methods for EOOO functionality provided herein have several advantages over existing OOO systems which are generally limited to sending OOO messages to email senders and are not capable of significant user customization to handle a wide range of situations, including event invitations. For instance, the systems and methods described herein enable the user to specify an extensive set of rules to govern the actions of the EOOO system.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

EOOO System

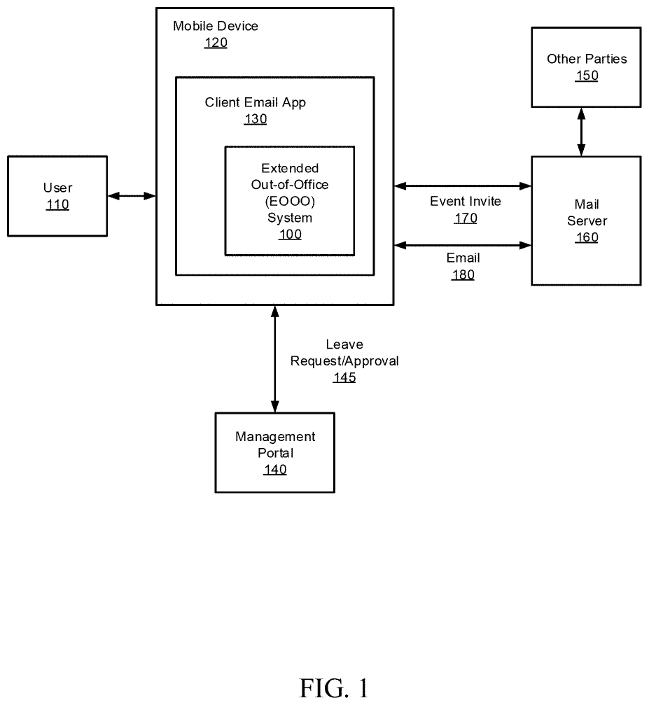

In some examples, an EOOO system is configured to extend the capabilities of a client email application to handle a wide variety of situations based on user specified rules. FIG. 1 is a top-level block diagram of a client email application 130 employing an EOOO system 100, in a mobile device platform 120 (although other platforms are possible), in accordance with an example of the present disclosure. As shown in FIG. 1, the client email application 130, employing EOOO system 100, interacts with a mail server 160, a management portal 140, and the user 110 of the device 120. Mail server 160 is configured to deliver meeting (or other event) invitations 170 and email 180 between the client email application 130 and other parties 150. In some examples, the interface between the mail server 160 and the client email application 130 may employ any suitable protocol, such as, for example, ActiveSync. Management portal 140 is configured to provide a communication channel for management-related messages between the user and management, which may include requests for leave and/or approval of leave requests.

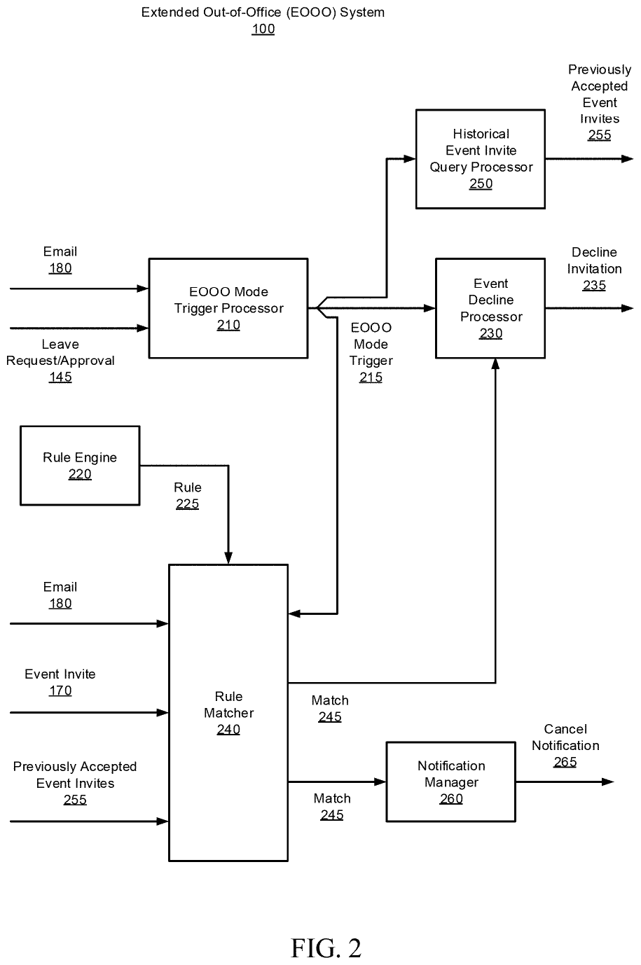

FIG. 2 is a block diagram of the EOOO system 100 of FIG. 1, in accordance with an example of the present disclosure. EOOO system 100 is shown to include an EOOO mode trigger processor 210, a rule engine 220, an event decline processor 230, a rule matcher 240, an historical event invite query processor 250, and a notification manager 260.

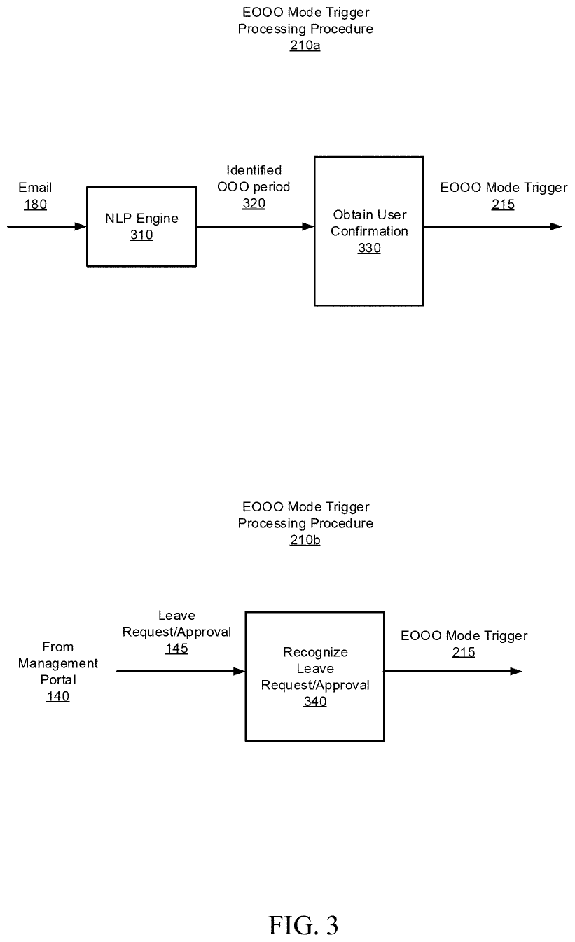

EOOO mode trigger processor 210 is configured to generate an EOOO mode trigger 215 based on incoming emails 180 of FIG. 1 and/or leave approval (or leave request) messages 145 of FIG. 1, as will be described in greater detail below in connection with FIG. 3. The EOOO mode trigger 215 serves to enable EOOO mode during appropriate time periods, such as when the user is on leave or otherwise requests EOOO mode to be in effect.

Historical event invite query processor 250 is configured to obtain a list of previously accepted (or marked as tentative) event invitations 255, which are scheduled to occur during the OOO period, so that the system may now consider declining those previously accepted invitations, as described below. In some examples, the accepted event invitations 255 may be obtained by querying or consulting a calendar maintained by the client email application 130 of FIG. 1, to record and track event invitations that have been accepted.

Rule engine 220 is configured to enable the user to define various rules or filters 225 which may be employed to determine whether or not it is appropriate to block email notifications, block event reminders, and/or decline event invitations. Email rules may include one or more of the following data items that can be matched to attributes of the email: a list of email senders, an email classification tag, an email importance tag, an email flag, an email destination folder, an email subject, a list of email recipients, a specified phrase in the email, and an instance of an at-sign in conjunction with a specified name (e.g., “@name”). For example, certain email senders may be identified as being relatively important, and thus notifications of emails received from these parties should not be blocked. As another example, the user may be expecting an email regarding a particular subject matter of importance to the user, and so particular keywords in the subject line or phrases in the body of the email may be specified in a rule preventing notifications of such emails from being blocked. As yet another example, the user may wish to specify a rule that the notification of emails that do not include an importance tag above a selected level (e.g., urgent) should be blocked.

Similarly, event rules may include one or more of the following data items that can be matched to attributes of the event invitation: event inviter, a list of event invitees, an event importance tag, an event flag, an event subject, and a specified phrase in the event invitation. For example, certain inviters or invitees may be identified as being relatively important, and thus invitations to these events should not be declined and reminders of these events should not be blocked.

It will be appreciated that the rules are fully customizable by the user and can be adapted to any situation. For example, the user can specify a rule that forwards selected emails to designated parties during the user's absence. In some examples, such a rule might be represented by the following syntax:
if email from abc@xyz then forward email to def@xyz
   although it will be appreciated that any suitable rule format or syntax may be used.

Rule matcher 240 is configured to apply the rules 225 to emails 180 received from the mail server, event invitations 170 of FIG. 1, and previously accepted event invitations 255. For example, using the rule described above, rule matcher 240, would extract the email source address from an incoming email 180 and compare it to the string “abc@xyz.” If the string compare results in a match (and if the EOOO mode trigger 215 is enabled), then an email forwarding action would be executed.

If the EOOO mode trigger 215 is enabled and a rule match is detected then match signal 245 is provided to event decline processor 230 and notification manager 260. Event decline processor 230 is configured to send a message 235 to the mail server 160 to decline an event invitation if the EOOO mode trigger 215 is enabled, and if rule matcher 240 generated a rule match 245 which indicated that an event invitation should be declined or that a previously accepted event invitation 255 should now be declined.

In some examples, the execution of event decline processing, as described above, may be moved to, or otherwise duplicated at, the mail server 160 so that this functionality continues to be available during times when the mobile device 120 is powered off or loses Internet connectivity.

Notification manager 260 is configured to instruct the client email application 130 of FIG. 1 to cancel notification 265 of an email if the EOOO mode trigger 215 is enabled, and if rule matcher 240 generated a rule match 245 which indicated that notification of the email should be blocked. In some examples, the notification manager 260 may be implemented as a wrapper around an existing notification system of the client email application 130, which decides, based on inputs from the rule matcher 240, whether or not to trigger the existing notification flow for a new email or event reminder. In some examples, in which the mail server 160 is configured to implement the functionality of declining meeting invitations during the OOO period, the mail server continues to handle meeting invitations by declining them while the client email application 130 handles notifications which are shown to the user.

EOOO Processes

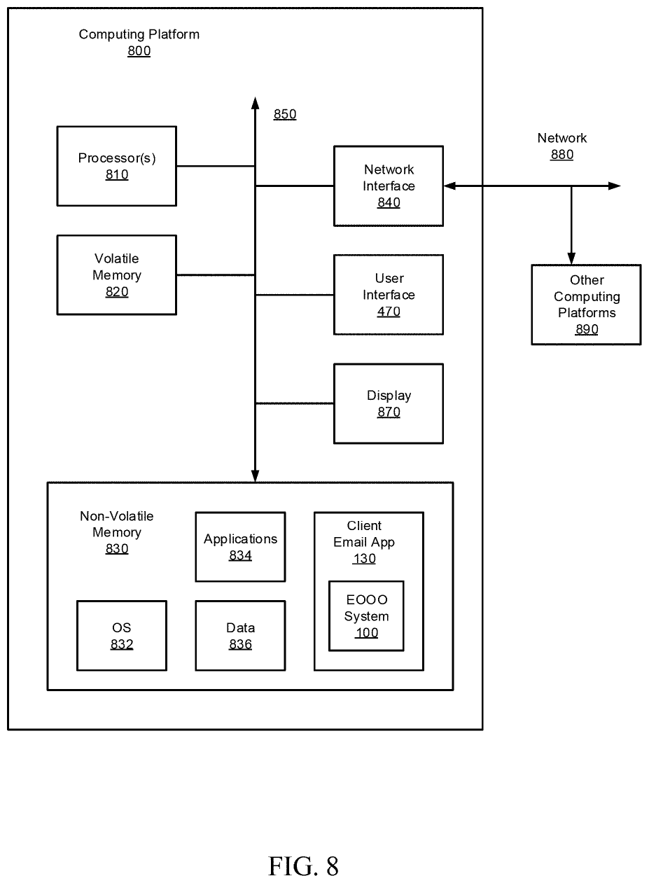

As described above, some examples of the EOOO system 100 of FIG. 1 are configured to provide improved capabilities for handling email and invitations by an email client during an OOO time period. The processes may be executed on a processor of any suitable type (e.g., processor 810 of FIG. 8).

FIG. 3 illustrates EOOO mode trigger processing procedures 210a and 210b, in accordance with an example of the present disclosure. In some examples 210a, a natural language processing engine 310 analyzes a received or transmitted email 180 of FIG. 1 and recognizes or identifies an OOO time period 320, based on the analysis. For example, the email 180 may contain text, either to or from the user, referencing a time period during which the user will be on leave such as “hello team, I will be away all of next week,” from the user, or “I heard you will be on vacation from x to y, hope you have a good time,” from a co-worker, or “your vacation request for dates x to y is approved,” from a manager. Natural language processing may be performed using any suitable technique in light of the present disclosure, including, for example, use of the Standford Core NLP suite, the Stanford Named Entity Recognition technique, the Natural Language Toolkit, and the Apache OpenNLP toolkit.

At operation 330, confirmation may be obtained from the user that the identified OOO time period is correct, before generating the EOOO mode trigger 215 of FIG. 2.

In some examples 210b, a management portal 140 of FIG. 1 may be monitored for requests and/or approvals of leave 145 of FIG. 1 for the user 110 of FIG. 1. At operation 340, if such request or approval is recognized or detected, the EOOO mode trigger 215 is generated.

In some example, the EOOO mode trigger 215 can be manually set by the user.

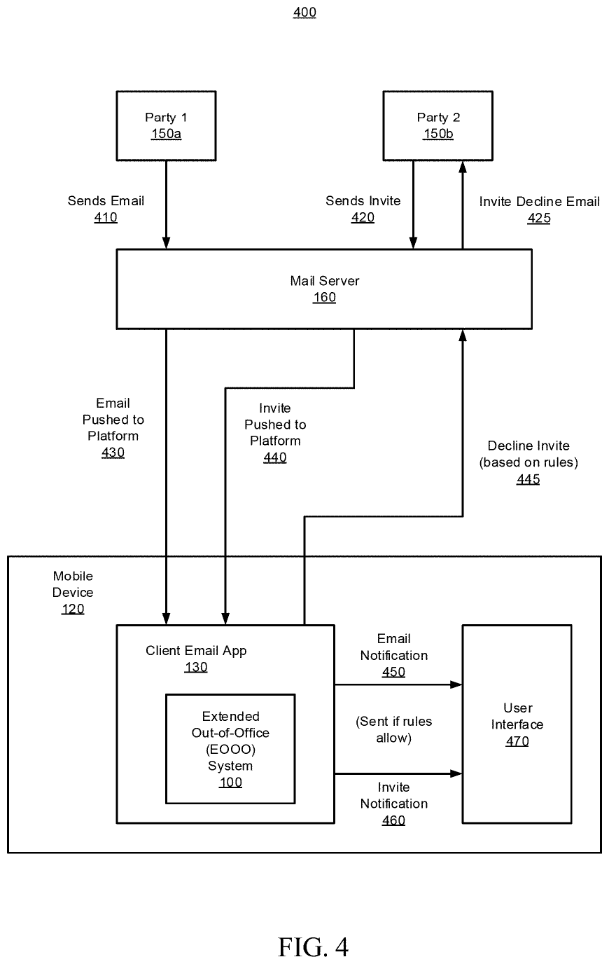

FIG. 4 illustrates EOOO mode processing procedures 400 for emails and invitations, in accordance with an example of the present disclosure. At operation 410, a first party 150a, sends an email to mail server 160 of FIG. 1. At operation 430, the mail server 160 pushes the email to the client email application 130 of FIG. 1 executing on the user platform (e.g., mobile device 120 of FIG. 1). At operation 450, the EOOO system 100 of FIG. 1 sends an email notification to the user, for example through user interface 470 of the mobile device, if application of the email rules to the email permits notification.

At operation 420, a second party 150b (which in some examples may be the same as the first party 150a) sends an event invitation to the mail server 160. At operation 440, the mail server 160 pushes the invitation to the client email application 130 executing on the user platform (e.g., mobile device 120). At operation 460, the EOOO system 100 sends an invite notification to the user, for example through user interface 470 of the mobile device, if application of the event rules to the invitation permits notification. Additionally, at operation 445, the EOOO system sends a message to the mail server to decline the invitation, if application of the event rules to the invitation indicates that the invitation should be declined. At operation 425, the mail server 160 send an email to the second party 150b informing them that the invitation has been declined.

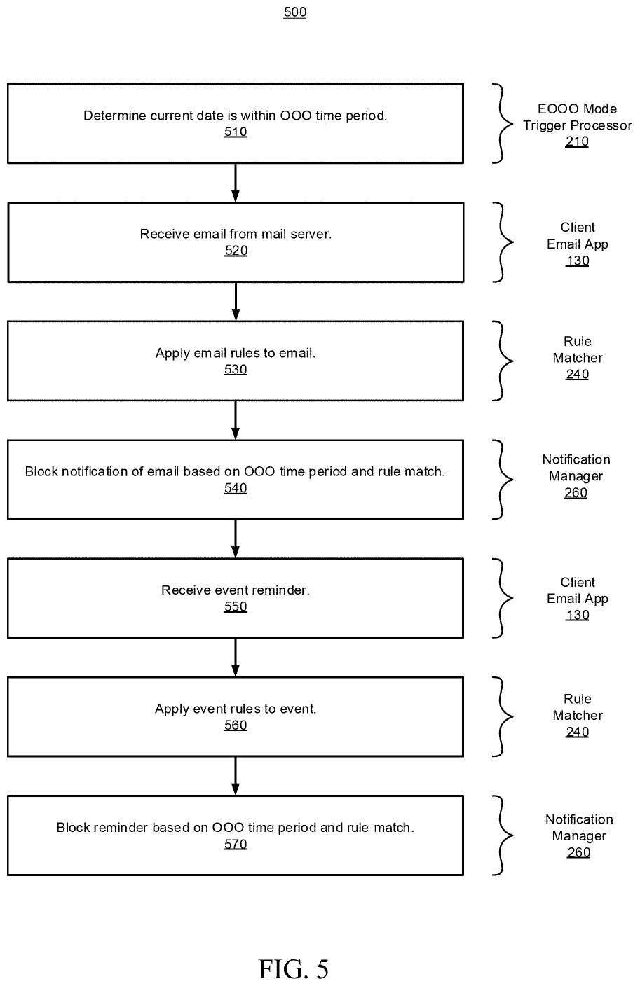

FIG. 5 is a flow diagram of a process for providing an EOOO mode to an email client, in accordance with an example of the present disclosure. The process 500 starts with detecting 510 that the current date and time is within an OOO time period. In some examples, the OOO time period may be specified by the user. In some examples, natural language processing is performed on emails received from the mail server to identify OOO time periods. In some examples, a management portal is monitored to identify leave requests and/or leave approval messages, from which OOO time periods may be determined.

Next, at operation 520, an email is received, by the client email application, from a mail server. At operation 530, a set of email rules is applied to the received email to determine that a notification of the email is allowed to be blocked. In some examples, the set of email rules include data items to be matched to attributes or information associated with the email to indicate that the notification of the email should not be blocked. The data items may include one or more of a list of email senders, an email classification tag, an email importance tag, an email flag, an email destination folder, an email subject, a list of email recipients, a specified phrase in the email, and an instance of an at-sign in conjunction with a specified name.

At operation 540, the notification of the email (to the receiver of the email, e.g., user 110 of FIG. 1) is blocked in response to the determination that the current date is within the OOO time period and the determination that the notification of the email is allowed to be blocked. In some examples, the set of event rules includes data items to be matched to attributes or information associated with the event to indicate that the event reminder should not be blocked and that the event invitation should not be declined. The data items may include one or more of an event inviter, a list of event invitees, an event importance tag, and event flag, an event subject, and a specified phrase in the event invitation.

At operation 550, a reminder of an event (e.g., a meeting) is generated by the client email application 130. In some examples the reminder may be generated based on a parsing of the invitation, originally received from the mail server, which can request that reminders be sent. At operation 560, a set of event rules is applied to the received event reminder to determine that the reminder is allowed to be blocked.

At operation 570, the reminder (to the invitee, e.g., user 110) is blocked in response to the determination that the current date is within the OOO time period and the determination that the reminder is allowed to be blocked.

In some examples, an invitation to an event is received from the mail server and a determination is made that the event is scheduled to occur during the OOO time period. The set of event rules is applied to the event to determine that the invitation is allowed to be declined, and if so, the invitation is declined if it occurs during the OOO time period.

In some examples, previously accepted event invitations, which can now be recognized as having been scheduled to occur during the OOO time period, are reconsidered. The set of event rules is applied to the event to determine that the previously accepted invitation is allowed to be declined, and if so, the invitation is declined.

### EOOO GUI Examples

The EOOO system (e.g., the EOOO system 100 of FIG. 1) is further configured to provide GUIs that enable the user to control and customize the operation of the EOOO system to meet the user's particular needs.

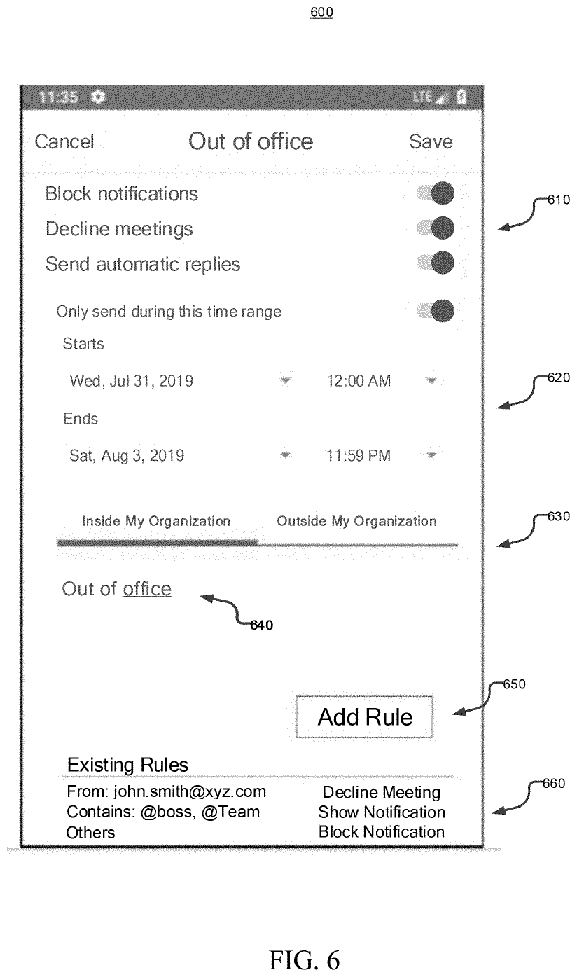

FIG. 6 illustrates a GUI 600 for the EOOO system, in accordance with an example of the present disclosure. In this example, toggle switches 610 are provided so that the EOOO system can be configured to block notifications, decline events and meetings, and send automatic replies, or so that these features can be turned off. Pull down menus 620 are also provided so that a starting date and time and an ending date and time for the OOO period can be specified. A slider control 630 is provided to offer a choice between emails and events that are inside the organization versus those that are outside the organization. An OOO button 640 is also provided so that the EOOO system can quickly and efficiently be informed that the user is currently out of the office (or has returned). With the press of button 640, the currently established settings and rules may thus be put into effect (or suspended), allowing a user on the move to quickly and easily enable or disable EOOO mode without having to navigate through multiple screens or applications.

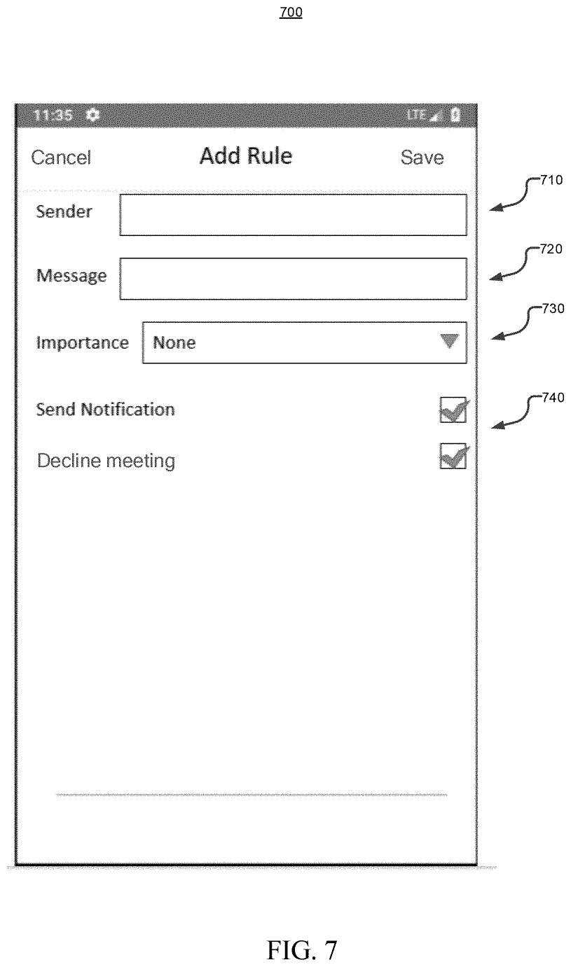

Button 650 is provided for adding a new rule (or edit existing rules) as will be discussed in connection with FIG. 7 below. An example of existing rules 660 are shown at the bottom of the screen. The rules indicate that meeting invitations from john.smith are to be declined, while emails from @boss and @team should result in notifications, although all other email notifications are to blocked. It will be appreciated that any other desired controls may be included in the GUI 600, in accordance with examples of the present disclosure.

FIG. 7 illustrates another GUI 700 for the EOOO system, in accordance with an example of the present disclosure. GUI 700 illustrates one example for adding a rule for handling an email or event invitation based on the specification of a sender 710, message details 720, and an importance level 730 (e.g., through a drop-down menu). Additionally, checkboxes 740 are provided to indicate whether a notification should be allowed or blocked and whether a meeting invitation should be declined, based on the application of the rule.

Computing Platform for EOOO

FIG. 8 is a block diagram of a computing platform configured to perform a process for providing an EOOO mode to an email client, in accordance with an example of the present disclosure. In some cases, the platform 800 may be a mobile device 120, as previously described in FIG. 1.

The computing platform or device 800 includes one or more processors 810, volatile memory 820 (e.g., random access memory (RAM)), non-volatile memory 830, user interface (UI) 470 of FIG. 4, one or more network or communication interfaces 840, a display or screen 870, and a communications bus 850. The computing platform 800 may also be referred to as a computer or a computer system.

The non-volatile (non-transitory) memory 830 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The display 870 can provide a graphical user interface (GUI) and in some cases, may be a touchscreen or any other suitable display device.

The user interface 470 can include one or more input/output (I/O) devices (e.g., a mouse, a keyboard, a microphone, a camera, one or more speakers, one or more biometric scanners, one or more environmental sensors, and one or more accelerometers, etc.).

The non-volatile memory 830 stores an operating system 832, one or more applications 834, data 836, and client email application 130 (including EOOO system 100) of FIG. 1, such that, for example, computer instructions of the operating system 832, the applications 834, and the client email application 130 and EOOO system 100, are executed by processor(s) 810 out of the volatile memory 820. In some examples, the volatile memory 820 can include one or more types of RAM and/or a cache memory that can offer a faster response time than a main memory. Data can be entered through the user interface 470 or received from the other devices. Email notifications 450 of FIG. 4 and invite notifications 460 of FIG. 4 may be sent through user interface 470 for presentation to the user on display 870. Various elements of the computing platform 800 can communicate via the communications bus 850.

The illustrated computing platform 800 is shown merely as an example client device or server and can be implemented by any computing or processing environment with any type of machine or set of machines that can have suitable hardware and/or software capable of operating as described herein.

The processor(s) 810 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 810 can be analog, digital or mixed. In some examples, the processor 810 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 840 can include one or more interfaces to enable the computing platform 800 to access a computer network 880 such as a Local Area Network (LAN), a Wide Area Network (WAN), a Personal Area Network (PAN), or the Internet through a variety of wired and/or wireless connections, including cellular connections. In some examples, the network 880 may allow for communication with other computing platforms 890, to enable distributed computing.

In described examples, the computing platform 800 can execute an application on behalf of a user of a client device. For example, the computing platform 800 can execute one or more virtual machines managed by a hypervisor. Each virtual machine can provide an execution session within which applications execute on behalf of a user or a client device, such as a hosted desktop session. The computing platform 800 can also execute a terminal services session to provide a hosted desktop environment. The computing platform 800 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

1. A computer system comprising:
a memory; and
at least one processor coupled to the memory and configured to:
determine that a current date is within an out-of-office (OOO) time period;
receive an email from a mail server;
apply a set of email rules to the email to determine that a notification of the email is allowed to be blocked;
block the notification of the email in response to the determination that the current date is within the OOO time period and the determination that the notification of the email is allowed to be blocked;
apply a set of event rules to an invitation to an event to determine that a reminder of the event is allowed to be blocked, wherein the reminder of the event is not the invitation to the event, and the set of event rules includes data items to be matched to attributes associated with the invitation to the event, a match indicating that a reminder of the event is allowed to be blocked, the data items including one or more of an event inviter, a list of event invitees, an event importance tag, an event flag, an event subject, or a specified phrase in the invitation to the event; and
block the reminder of the event in response to the determination that the current date is within the OOO time period and the determination that the reminder of the event is allowed to be blocked.

2. The computer system of claim 1, wherein the event is a first event and the at least one processor is further configured to:
receive an invitation to a second event from the mail server;
determine that the second event is scheduled to occur during the OOO time period;
apply the set of event rules to the invitation to the second event to determine that the invitation to the second event is allowed to be declined; and
decline the invitation to the second event in response to the determination that the second event is scheduled to occur during the OOO time period and the determination that the invitation to the second event is allowed to be declined.

3. The computer system of claim 1, wherein the event is a first event and the at least one processor is further configured to:
determine that a second event is scheduled to occur during the OOO time period, the second event associated with a previously accepted invitation;
apply the set of event rules to the previously accepted invitation to determine that the previously accepted invitation is allowed to be declined; and
decline the previously accepted invitation in response to the determination that the second event is scheduled to occur during the OOO time period and the determination that the previously accepted invitation is allowed to be declined.

4. The computer system of claim 1, wherein the at least one processor is further configured to perform natural language processing on one or more additional emails received from the mail server to identify the OOO time period.

5. The computer system of claim 1, wherein the at least one processor is further configured to receive a leave approval message from a management portal and identify the OOO time period based on the leave approval message.

6. The computer system of claim 1, wherein the set of email rules includes data items to be matched to attributes associated with the email, a match indicating that the notification of the email should not be blocked, the data items including one or more of a list of email senders, an email classification tag, an email importance tag, an email flag, an email destination folder, an email subject, a list of email recipients, a specified phrase in the email, or an instance of an at-sign in conjunction with a specified name.

7. The computer system of claim 1, wherein a match indicates that a reminder of the event should not be blocked and that an invitation to the event should not be declined.

8. A method for providing an enhanced out-of-office (OOO) mode to an email client comprising:
determining, by a computer system, that a current date is within an OOO time period;
receiving, by the computer system, an email from a mail server;
applying, by the computer system, a set of email rules to the email to determine that a notification of the email is allowed to be blocked;
blocking, by the computer system, the notification of the email in response to the determination that the current date is within the OOO time period and the determination that the notification of the email is allowed to be blocked;
applying, by the computer system, a set of event rules to an invitation to an event to determine that a reminder of the event is allowed to be blocked, wherein the reminder of the event is not the invitation to the event, and the set of event rules includes data items to be matched to attributes associated with the invitation to the event, a match indicating that a reminder of the event is allowed to be blocked, the data items including one or more of an event inviter, a list of event invitees, an event importance tag, an event flag, an event subject, or a specified phrase in the invitation to the event; and
blocking, by the computer system, the reminder of the event in response to the determination that the current date is within the OOO time period and the determination that the reminder of the event is allowed to be blocked.

9. The method of claim 8, wherein the event is a first event, further comprising:
receiving an invitation to a second event from the mail server;
determining that the second event is scheduled to occur during the OOO time period;
applying the set of event rules to the invitation to the second event to determine that the invitation to the second event is allowed to be declined; and
declining the invitation to the second event in response to the determination that the second event is scheduled to occur during the OOO time period and the determination that the invitation to the second event is allowed to be declined.

10. The method of claim 8, wherein the event is a first event, further comprising:
determining that a second event is scheduled to occur during the OOO time period, the second event associated with a previously accepted invitation;
applying the set of event rules to the previously accepted invitation to determine that the previously accepted invitation is allowed to be declined; and
declining the previously accepted invitation in response to the determination that the second event is scheduled to occur during the OOO time period and the determination that the previously accepted invitation is allowed to be declined.

11. The method of claim 8, further comprising performing natural language processing on one or more additional emails received from the mail server to identify the OOO time period.

12. The method of claim 8, further comprising receiving a leave approval message from a management portal and identifying the OOO time period based on the leave approval message.

13. The method of claim 8, wherein the set of email rules includes data items to be matched to attributes associated with the email, a match indicating that the notification of the email should not be blocked, the data items including one or more of a list of email senders, an email classification tag, an email importance tag, an email flag, an email destination folder, an email subject, a list of email recipients, a specified phrase in the email, or an instance of an at-sign in conjunction with a specified name.

14. The method of claim 8, wherein a match indicates that a reminder of the event should not be blocked and that an invitation to the event should not be declined.

15. A non-transitory computer readable medium storing executable sequences of instructions to provide an enhanced out-of-office (OOO) mode to an email client, the sequences of instructions comprising instructions to:
determine that a current date is within an OOO time period;
receive an email from a mail server;
apply a set of email rules to the email to determine that a notification of the email is allowed to be blocked;
block the notification of the email in response to the determination that the current date is within the OOO time period and the determination that the notification of the email is allowed to be blocked;
apply a set of event rules to an invitation to an event to determine that a reminder of the event is allowed to be blocked, wherein the reminder of the event is not the invitation to the event, and the set of event rules includes data items to be matched to attributes associated with the invitation to the event, a match indicating that a reminder of the event is allowed to be blocked, the data items including one or more of an event inviter, a list of event invitees, an event importance tag, an event flag, an event subject, or a specified phrase in the invitation to the event; and
block the reminder of the event in response to the determination that the current date is within the OOO time period and the determination that the reminder of the event is allowed to be blocked.

16. The non-transitory computer readable medium of claim 15, wherein the event is a first event and the sequences of instructions further include instructions to:
receive an invitation to a second event from the mail server;
determine that the second event is scheduled to occur during the OOO time period;
apply the set of event rules to the invitation to the second event to determine that the invitation to the second event is allowed to be declined; and
decline the invitation to the second event in response to the determination that the second event is scheduled to occur during the OOO time period and the determination that the invitation to the second event is allowed to be declined.

17. The non-transitory computer readable medium of claim 15, wherein the event is a first event and the sequences of instructions further include instructions to:
determine that a second event is scheduled to occur during the OOO time period, the second event associated with a previously accepted invitation;
apply the set of event rules to the previously accepted invitation to determine that the previously accepted invitation is allowed to be declined; and
decline the previously accepted invitation in response to the determination that the second event is scheduled to occur during the OOO time period and the determination that the previously accepted invitation is allowed to be declined.

18. The non-transitory computer readable medium of claim 15, wherein the sequences of instructions further include instructions to perform natural language processing on one or more additional emails received from the mail server to identify the OOO time period.

19. The non-transitory computer readable medium of claim 15, wherein the sequences of instructions further include instructions to receive a leave approval message from a management portal and identify the OOO time period based on the leave approval message.

20. The non-transitory computer readable medium of claim 15, wherein the set of email rules includes data items to be matched to attributes associated with the email, a match indicating that the notification of the email should not be blocked, the data items including one or more of a list of email senders, an email classification tag, an email importance tag, an email flag, an email destination folder, an email subject, a list of email recipients, a specified phrase in the email, or an instance of an at-sign in conjunction with a specified name.

21. The non-transitory computer readable medium of claim 15, wherein a match indicates that a reminder of the event should not be blocked and that an invitation to the event should not be declined.
